(19) United States
(12) Patent Application Publication
(10) Pub. No.: US 2007/0038811 A1
(43) Pub. Date: Feb. 15, 2007

(54) Playback system and method supporting improved trick mode performance for disc-based multimedia

(75) Inventor: Koen J. G. Holtman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN NETHERLANDS (NL)

(21) Appl. No.: 10/573,746

(22) PCT Filed: Sep. 28, 2004
(86) PCT No.: PCT/IB04/51900

§ 371 Date: Mar. 28, 2006

(30) Foreign Application Priority Data
Sep. 30, 2003 (US) 60507091

(51) Int. Cl. G06F 12/00

(52) U.S. Cl. 711/133

(57) ABSTRACT

A playback apparatus and associated method is disclosed for use in a reproducing system, the apparatus including a cache memory configured to store data read from a data source (1); a cache replacement unit (341) configured to identify certain of the data to be deleted from the cache memory (335) based on a determination of the data source data's use in at least two play modes of the apparatus; and a presentation unit (337) configured to obtain data from the cache memory (335) to be presented to a user. The playback apparatus further includes a disc control unit (343) configured to identify data to be read from the data source (1) to be stored in the cache memory (335) based on the current contents of the cache memory (335).

The present invention relates to video recorder and playback systems, and more particularly to an optical disk playback system and improved trick-mode performance therein.

The description which follows uses the terminology defined below:
MPEG (Motion Picture Experts Group)—is the name given to a family of International Standards used for coding audio-visual information in a digital compressed format. MPEG standards include MPEG-1, MPEG-2 and MPEG-4, to suit different bandwidth and quality constraints. MPEG-2, for example, is especially suited to the storage and transmission of broadcast quality television programs.
Fragment—a portion of an MPEG stream. Typically every 15^{th} frame of an MPEG stream is encoded as an I frame. A fragment is defined as either an I-frame, or that portion of an MPEG stream between two consecutive encoded I frames boundaries having typically 14 frames of information in-between.

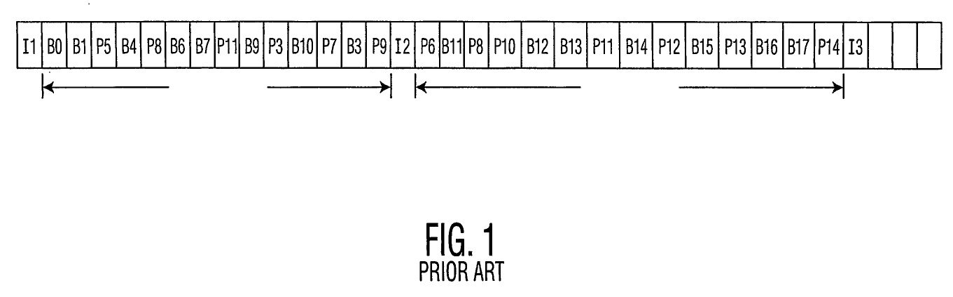

FIG. 1 is an illustration of an exemplary MPEG data stream illustrating five fragments 101-105. As shown, frames I1, I2, and I3 represent fragments 101, 103 and 105, respectively and fragments 102 and 104 are comprised of 14 frames of information bounded on either side by I frames. It is noted that in some implementations, fragment boundaries will not coincide exactly with the byte positions where an I-frame begins or ends, but positioned somewhat before or after these byte positions so as to be in alignment with optical disc sector boundaries.

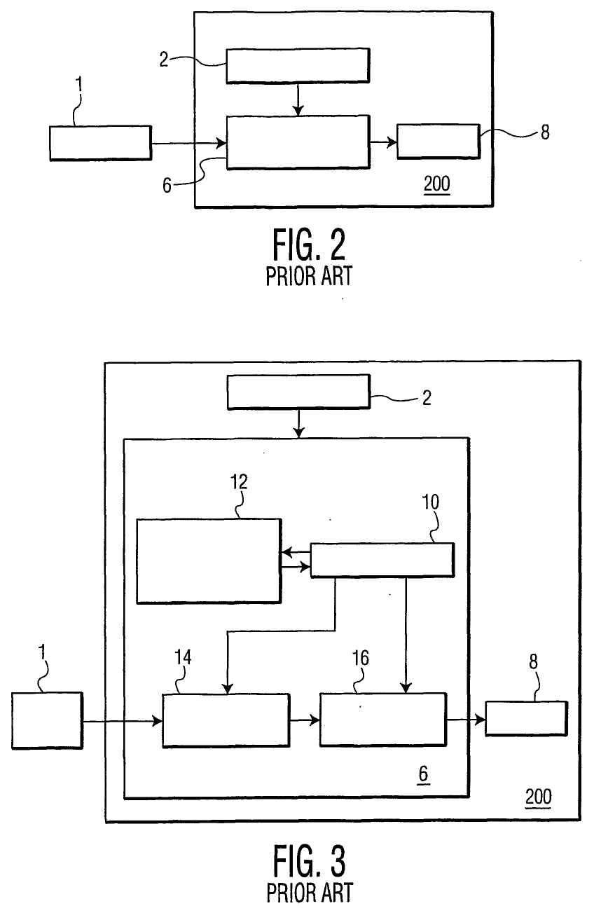

FIG. 2 is a high-level block diagram of a prior art optical disk reproducing system 200 for playing back an Optical Disc. The optical disk reproducing system 200 comprises a user interface 2, a playback unit 6 and an external display 8. The optical disk reproducing system 200 provides playback of the optical disk, inserted in disc drive 1, in either forward or reverse directions at speeds slower or faster than a normal playback speed. Such non-standard speed playback features are known in the art as trick modes or trick play (e.g., fast-forward, pause, rewind, etc.). Playback unit 6 is primarily responsible for executing the various playback features including the trick modes. An example of a trick mode is skipping of selected frames so as to obtain a fast forward mode. Another example of a trick mode could be accessing a contiguous sequence of frames repeatedly, commonly referred to as A-B loop play. The disk reproduction system 200 also has a user interface structure 2 to accept user instructions for the system 200. The user interface structure is comprised for instance of operating switches and buttons, remote controller, keyboard and liquid crystal display devices, etc.

FIG. 3 is a more detailed block diagram of the playback unit 6 of the reproducing system 200 of FIG. 2 in accordance with the prior art. The playback unit 6 comprises a controller 10 for controlling all disk related operations, a current playback position unit 12 that is used by the controller to hold the current position where the playback happens, a FIFO buffer 14 for storing fragments which may be requested by the presentation unit 16 for display on the display 8. The controller 10 controls the playback (including trick mode playback) of the data stored on the optical disk in the disc drive 1. The controller 10 may be included within a single device or separate devices. The controller 10 is bi-directionally coupled to the current playback position unit 12 which provides a ‘current playback position’ pointer to the controller 10. The current playback position pointer is moved forward and backward to determine the next video fragment to be read from the optical disk.

In normal ‘play’ mode, the pointer is moved forward in a linear fashion without ‘jumps’. In a ‘fast’ trick mode the pointer skips portions of the material. The skipping distance is either constant (e.g., in Fast-Forward every 4^{th} I frame which is equivalent to 60 frames), or controlled via a feedback loop. The disc drive 1 receives commands from the controller 10 to read a fragment of information of a certain size from a certain location on the optical disk. The fragments that are read are pushed into the FIFO buffer 14 which eventually passes the fragments on to the presentation unit 16 for display on the external display device 8.

The conventional optical disk reproducing system 200 of FIGS. 2 and 3 suffers from a number of drawbacks including: (1) the execution of efficient (i.e. fast) transitions between the different trick modes requires a relatively complicated controller 10; (2) transitions from one mode to another present problems related to storage, control, latency and timing, all of which demand a significant investment of design, coding, debugging, and tuning time; and (3) the controller has difficulty dealing with data streams that are not stored fully sequentially on a disc or similar storage medium. If a ‘gap’ in the data stream must be crossed by the disc drive, this may lead to delays that could cause a FIFO buffer underrun. Buffer underrun occurs when the disk reproducing system fails to sustain the data stream from the optical disk for the duration of the reproduction process (this may be overcome by using a more complex controller or by using a presentation unit that can deal with an empty FIFO buffer ) and (4) in the case of A-B loop play, when the points A and B are very close together, it becomes a difficult situation to handle without incurring undesirable buffer underruns, which may be overcome by adding controller complexity.

Accordingly, there is a need for a simpler system design which overcomes the aforementioned drawbacks of the prior art.

The present invention overcomes the aforementioned drawbacks and provides an optical disk playback apparatus for use in an optical disk reproducing system.

According to an aspect of the present invention, a playback apparatus for use in a reproducing system including a plurality of play modes, includes in one embodiment: a cache memory configured to store data to be read from a data source; a cache replacement unit configured to identify certain of said stored data to be deleted from the cache memory based on a determination of said stored data's present and/or future use in at least two play modes from among said plurality of play modes; and a presentation unit configured to retrieve data from the cache memory to be presented to a user.

According to another aspect of the present invention, a method for improving trick mode performance in a reproducing system includes: reading data from a data source; storing said data in a cache memory; identifying certain of said stored data to be deleted from the cache memory based on a determination of said stored data's present and/or future use in at least two play modes from among said plurality of play modes; and retrieving data from the cache memory to be presented to a user.

The playback apparatus of the invention advantageously uses a cache memory in lieu of a conventional FIFO buffer to store data retrieved from an optical disk capable of storing a contiguous or non-contiguous data stream. The advantages over a conventional FIFO buffer include: making the cache memory randomly addressable to allow selection of data in the cache memory in anticipation of an unpredictable trick mode transition, and allowing the stored data to remain in the cache in anticipation of future trick mode transitions.

The foregoing features of the present invention will become more readily apparent and may be understood by referring to the following detailed description of an illustrative embodiment of the present invention, taken in conjunction with the accompanying drawings, where:

FIG. 1 is an illustration of a partial MPEG stream including a plurality of fragments in accordance with the prior art;

FIG. 2 is a block diagram of a video disk reproducing system for playing back an optical disk in accordance with the prior art;

FIG. 3 is more detailed illustration of a playback unit of the system of FIG. 2;

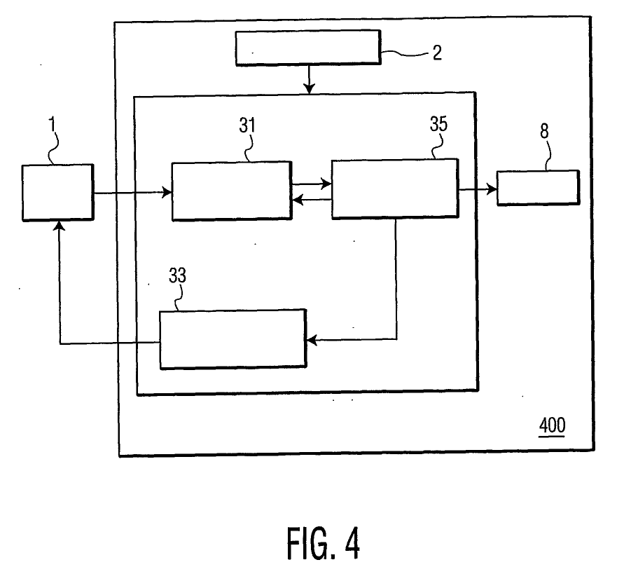

FIG. 4 is a block diagram depicting a video disk playback system for playing back an optical disc according to one embodiment of the invention; and

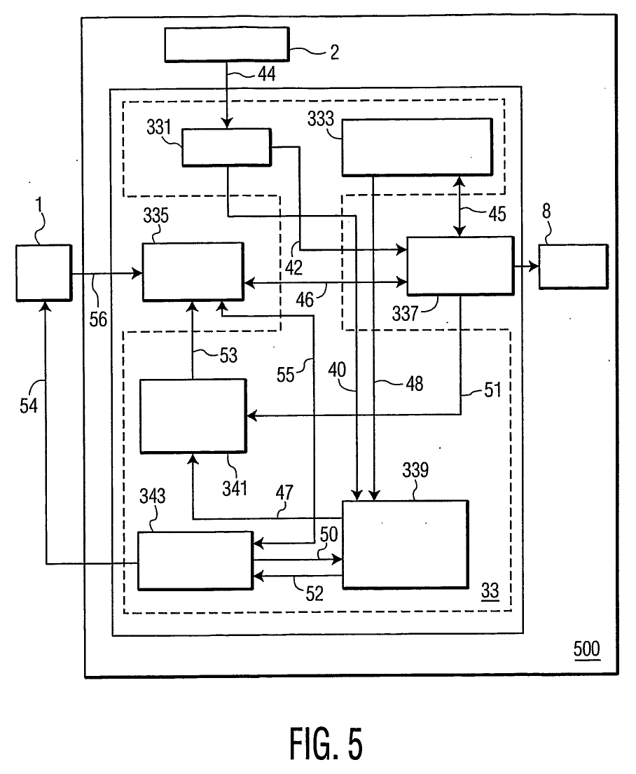

FIG. 5 is more detailed illustration of a playback unit of FIG. 4.

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing-limitations upon, the claimed invention.

It is contemplated that the disclosed systems, methods and apparatus may find general applicability to any device having a capability of playing back multimedia content from a disc. The playback apparatus of the invention is particularly applicable if the apparatus subscribes to at least the following criteria:

(1) the apparatus uses a disc drive with a slow random access response time or any other medium having a slow random access latency. For example, a wide area network link, especially when routed through satellites;

(2) the apparatus uses a disc format where the content is not always assumed to be laid out linearly; and

(3) the apparatus has a limited memory budget such as a consumer electronic device (i.e., hand-held computers, pocket-sized computers, personal digital assistants, mobile phones and other electronic devices).

The playback apparatus of the invention may be described in the general context of computer-executable instructions, such as program modules, being executed by a microprocessor. Generally, program modules include routines, programs, objects, components, data structures, and so forth. Computer storage media defined herein includes but is not limited to, CD-ROM, digital versatile disks (DVD) or other optical disk storage, or any other medium which can be used to store the desired information and which can accessed by the computer.

FIG. 4 illustrates a high-level block diagram of a disc playback system 400 in accordance with an embodiment of the invention. The disc playback system 400 includes a disk drive 1, a user interface 2, a playback unit 6 and an external display 8. Playback unit 6 is comprised of trick mode cache 31, cache and disc control unit 33 and presentation unit 35.

FIG. 5 is a more detailed block diagram of the disk playback system 400 of FIG. 4 in accordance with an embodiment of the invention. FIG. 5 illustrates the modules which comprise cache and disc control unit 33 of the disk playback system 400 of FIG. 4. As shown, the cache and disc control unit 33 includes: i) mode unit 331; ii) current fragment position unit 333; iii) access prediction unit 339; iv) cache replacement unit 341; v) disc control unit 343; vi) trick mode cache 335 and vii) presentation unit 337.

It is to be appreciated that in alternate embodiments, the access prediction unit 339 may be physically removed while retaining its functionality to be divided among and embodied within in the disc control unit 343 and cache replacement unit 341. In other words, the disc control unit 343 and cache replacement unit 341 may have access prediction functionality built in.

The following description describes the overall operation of the novel playback system 500 shown in FIG. 5, according to one embodiment, by providing a functional description of the units which comprise the system 500.

Mode Unit 331

The mode unit 331 interfaces with the presentation unit 337 (via line 42), and the access prediction unit 339 (via line 40).

In operation, when a mode change is received from the user interface 2 on line 44, the mode unit 331 stores the new mode status. Once stored, the mode unit 331 then outputs the new mode status and any applicable A-B loop play information to the presentation unit 337 on line 42 including information about any applicable pointer position changes to inform the presentation unit 337 as to where it should continue operating. The presentation unit 337 informs the current fragment position unit 333 of the applicable pointer position changes, if they exist, by sending an updated fragment position value on line 45. The mode unit 331 also outputs the mode status and any applicable A-B loop play information to the access prediction unit 335 on line 40.

In general, the mode status is comprised of commands for allowing a user to control the operations of the optical disc playback systems 400, 500 shown in FIGS. 4-5. For example, the mode status may include commands as follows: “PLAY” instructing to perform playback; trick-play commands such as “FF” fast-forward), “REW” (fast rewind), “SLOW” (slow motion), and the like; “SEARCH” instructing to search for scene or time; “STOP” instructing to stop the playback; “PAUSE” instructing to pause the playback; a command for setting playback mode; and the like. Of course, the commands are not restricted to those mentioned above, and may be composed of arbitrary commands for controlling the optical playback systems 400, 500.

It is noted that in alternate embodiments, the functionality of the mode unit 331 could be replicated and/or duplicated in whole or in part one or more other units.

Current Fragment Position Unit 333

Current fragment position unit 333 interfaces with the access prediction unit 339 (via line 48) and the presentation unit 337 (via line 45). It should be understood that the lines interconnecting the various units may be unidirectional, bidirectional or bus lines.

The current fragment position unit 333 (1) receives and stores the position of the fragment that is currently being displayed by the presentation unit 337 on bi-directional line 45; and (2) outputs the current fragment position to the access prediction unit 339 (via line 48).

Presentation Unit 337

Presentation unit 337 interfaces with the trick mode cache 335, the current fragment position unit 333, via line 45, the mode unit 331, via line 42, and the display 8.

The presentation unit 337, in one aspect, includes a timing mechanism that initiates the presentation of successive fragments, as required by modes such as “Play” and “FF”. The internal timing mechanism relies on the mode value of the mode unit 331 to advance or retard the value stored in the current fragment position unit 333.

The presentation unit 337 presents the current fragment, with the identity of the current fragment, received via line 45 from the current fragment position unit 333 and makes requests for fragments from the trick mode cache 335 on bidirectional line 46 for display on external display 8.

Whenever the fragment position changes, the presentation unit 337 will attempt to request the new fragment from the trick mode cache 335.

In the event a request for a fragment made by the presentation unit 337 cannot be satisfied because the fragment is not currently stored in the trick mode cache 335 (i.e., a cache miss), the presentation unit 337 compensates for the missing data by continuing to output the last frame of the most recently displayed fragment (i.e., freeze frame). In the case of a cache miss, the functioning of the internal timing mechanism that advances the fragment position unit 333 may be influenced. For example, after a number of cache misses in PLAY mode, the timing mechanism might advance the fragment position ‘30 seconds ahead’ in an attempt to jump over a bad area on the disc. It is noted that such heuristic manipulations of the current playback position are well known in the art.

Disc Control Unit 343

The disc control unit 343 interfaces with the disc drive 1 via line 54, the access prediction unit 339 via lines 50, 52 and the trick mode cache via line 55.

The disc control unit 343 instructs the disc drive 1 to read fragments on command line 54. The disc control unit 343 also commands the access prediction unit 339 on command line 50 to send the most recently generated fragment list via data line 52.

The disc control unit 343 commands the access prediction unit 339 to generate and deliver a fragment list. Upon receiving the fragment list from the access prediction unit 339, via data line 52, the disc control unit 343 utilizes a fragment selection algorithm to select a single fragment from the fragment list. Once selected, the remainder of the fragment list is discarded by the disc control unit 343.

Upon selecting a single fragment from the fragment list in accordance with one of the approaches to be described below, the disc control unit 343 then instructs the disc drive 1 on line 54 to retrieve the selected fragment using one or more commands in the command language appropriate for the disc drive 1. Responsive to these commands, the disc drive 1 outputs the retrieved fragment to the trick mode cache 335 on line 56.

The process of selecting a single fragment from the fragment list by the fragment selection algorithm of the disc control unit 343, according to one embodiment, is now described.

The fragment selection algorithm has knowledge of the current contents of the trick mode cache 335. Knowing its contents, the algorithm first reviews the contents of the fragment list {f₁, f₂, f₃, f₄, . . . } and eliminates all fragments that are already present in the trick mode cache 335. Having eliminated these fragments, the fragment selection algorithm may then utilize any number of approaches to select a single fragment from the narrowed-down fragment list.

A first approach for selecting a single fragment is to pick the first fragment of the narrowed-down list.

A second approach has the additional objective to select a fragment that also optimizes the disc drive seek pattern. This second approach selects a single fragment from the narrowed-down fragment list having the lowest numerical value computed by a tradeoff function T defined as:
T (distance of fₓ to start of list, distance of fₓ to current disc position) Eq.[1]

Equation (1) describes a tradeoff function T which trades off two computed values for the fragment fₓ from the fragment list. The first computed value is the “distance of the fragment fₓ to the start of the fragment list”. Fragments closer to the head of the fragment list have a greater likelihood of being requested and therefore yield a higher numerical value.

The second computed value, i.e., “distance of fₓ to current disc position”, is the distance of fragment fₓ to the current disc drive read/write head position. The lower the distance, the higher the resulting value.

The tradeoff function T computes both values and returns a weighted combination of the two computed values for each element fₓ in the fragment list. This weighted combination is an increasing function in both arguments, meaning that T(X,Y) yields a higher function value both if X is increased and if Y is increased. An example of an appropriate T is T(XY)=X+C*Y, with C a constant. The exact parameters of the weighting function T (e.g., the constant C) are tuned or determined in such a way as to create an optimal seek pattern, given the specific performance parameters of the disc drive 1.

As previously stated, a single fragment is then selected from the narrowed down fragment list having the lowest numerical value computed by the tradeoff function T′.

As the disc control unit 343 uses a fragment list created by the access prediction unit, and as the access prediction unit 339 takes into account at least two play modes when creating a fragment list, it therefore follows that the disc control unit takes at least two play modes into account when deciding which fragments to request.

It is noted that the generation of a fragment list represents one way to perform access prediction. Other representations for ranking fragments are also within contemplation of the invention.

In accordance with another embodiment, the invention does not consider the use of an access prediction unit 339. Rather, the disc control unit 343 incorporates the functionality of the access prediction unit 339. Specifically, the disc control unit 343 identifies data blocks to be read from the data source 1 based on the current contents of the cache 335. Identification of the data blocks to be read may be performed via a prioritization control mechanism which prioritizes some number of candidate data blocks to select one candidate data block to be read. The prioritization includes the acts of identifying at least two candidate data blocks which are not currently present in the cache memory 335, assigning a desirability figure to the candidate data blocks, and selecting the data block having the highest desirability figure. The desirability figure may be based upon criteria including, but not limited to, at least a relative importance of the respective play modes.

In another embodiment, the disc control unit 343 is configured to predictively select data stored on the data source 1 based on a heuristic algorithm. The heuristic algorithm selects data from the data source by predicting the likelihood that the data will be requested from the cache memory 335 at a future time, assigns a prediction score based on the prediction and selects data from the data source 1 having the highest prediction scores. The heuristic algorithm takes into consideration criteria including, but not limited to, a knowledge of the current play mode, a current fragment position, a knowledge of fragment access patterns in a plurality of play modes, a probability that the current mode will be maintained and a probability that a mode other than the current play mode will be selected.

Trick Mode Cache 335

The trick mode cache 335 interfaces with the disc drive 1 via line 56, the cache replacement unit 341 via line 53 and the presentation unit 337 via line 46.

The trick mode cache 335 stores the fragments received from disc drive 1 under control of the disc control unit 343. Any one of the fragments stored in the trick mode cache 335 may eventually be requested by the presentation unit 337on the bidirectional line 46 at a future time.

A feature of the trick mode cache 335 is that it may be randomly addressed by the presentation unit 337 to request fragments in anticipation of a transition to any of the allowable trick and/or play modes. This capability was unavailable in the prior art playback unit employing a FIFO buffer. It is noted that in alternate embodiments, the trick mode cache 335 may be addressed to request data segments other than fragments, such as disc sector numbers.

Another feature of the trick mode cache 335 and its corresponding control logic in this embodiment is that when the presentation unit 337 requests a fragment for display, the retrieved fragment is not automatically deleted or purged from the trick mode cache 335. This feature is provided in anticipation of a transition to any of the allowable trick and/or play modes.

Another feature of the trick mode cache 335 and its corresponding control logic in this embodiment is that it is a predictive cache which differs from a normal cache in that a conventional cache is only filled when the user of the cache requests a piece of data not already present in the cache. A predictive cache is filled by a separate mechanism that tries to predict future requests.

Another feature of the trick mode cache 335 is that there is no implied requirement on the control logic surrounding the cache to ensure that, if the presentation unit 337 requests data (e.g., one or more fragments), the requested data has to be present and available in the cache. This is different from conventional FIFO solutions in which the requested data must be present in the FIFO buffer. Whenever requested data is not present in the cache, a cache miss will occur and the presentation unit 337 will continue to output the last frame of the most recently displayed fragment (i.e., freeze frame).

Access Prediction Unit 339

The access prediction unit 339 interfaces with the current fragment position unit 333 (via line 48), the mode unit 331 (via line 40), the cache replacement unit 341 (via line 47) and disc control unit 343 (via lines 50, 52).

The access prediction unit 339 performs access prediction to generate a fragment list comprised of fragments which are most likely to be accessed in the future by a user. The fragment list may be represented as {f₁, f₂, f₃, f₄, . . . } with f₁ being the fragment that is most likely to be accessed in the future.

In the preferred embodiment, the length of the fragment list that is created by the access prediction unit 339 is (F+1)*M, representing the number of fragments in the list, where F is the estimated maximum number of fragments that can fit into the trick mode cache 335. This estimation is needed because fragments in a MPEG-2 stream can have a variable size, with a realistic minimum size being dictated by authoring quality considerations. The variable M is the number of different play modes under consideration by the access prediction unit.

In other embodiments, it is to be appreciated that shorter or longer lists may be generated. In particular, variable-size lists, which are usually shorter, can be generated when the receiving unit gives some signal to the access prediction unit 339, indicating that it has received sufficient elements to make its decision. This use of a signal is especially applicable if the access prediction task is integrated into the disc control unit 341 and/or cache replacement unit 343. In such an integrated case, it is possible (and sometimes preferable depending on the implementation method used) to utilize an embodiment that does not use a list data structure at all, or an embodiment that intermingles into a single algorithm, the tasks of generating the prediction and selecting fragments (to fetch or delete).

The access prediction unit 339 utilizes a prediction algorithm to predict those fragments that are most likely to be accessed in the future by the presentation unit 337. In order to make predictions of those fragments that are most likely to be accessed in the future, the presentation unit 337 receives input information from the mode unit 331 and current fragment position unit 333.

In the prior art, access prediction is typically performed as a linear extrapolation of the current play mode from the current fragment playback position in a direction determined by the mode. A list of fragments is output and this list represents the linear extrapolation of the current play mode. By contrast, a key feature of the invention is that access prediction does not simply account for the current play mode, but also considers other play modes that the user may switch to in the future. In the simplest case, access prediction considers at least one mode other than the current play mode. Accordingly, the access prediction unit outputs a fragment list that contains fragments needed by the current play mode and in addition, fragments needed by the at least one other mode. In a more complex implementation, one or more additional modes may be taken into account when performing access prediction. It is therefore shown that access prediction reflects the probability that the current mode will be maintained and in addition, the probability that modes different than the current play mode will be selected by the user in the future.

In light of the fact that access prediction considers multiple play modes, coupled with an understanding that the results of access prediction are fed into the cache replacement unit and the disc control unit, it is understood that both these units are also configured, in the preferred embodiment, to take more than one mode into account in making their decisions about which fragments to delete or request.

While the above description of the access prediction unit emphasizes ‘prediction’ as a central principle, other embodiments, that de-emphasize prediction and use some other ranking method, are within contemplation of the invention. In the most generalized case, all that is required of the access prediction unit is that it contain a heuristic algorithm that has the effect of optimizing trick mode performance.

In an alternative embodiment, the access prediction unit may be replaced by a ‘desirability ranking unit’, which assigns a desirability figure to each fragment in such a way that fragments that are more desirable to have in the cache memory have a higher desirability figure. The desirability figure may be based on criteria including, but not limited to, a relative importance metric of at least two play modes that at least two candidate fragments may be used in and a distance between the at least two candidate data blocks to a current playback position.

In an embodiment that employs a desirability ranking unit, the output is preferably a fragment list, with the most desirable fragment at the front of the list. As this fragment list is fed to into the cache replacement unit and the disc control unit, it is understood that both these units are also configured to use a desirability ranking methodology (i.e., taking more than one mode into account, in making their decisions about which fragments to delete or request).

Cache Replacement Unit 341

The cache replacement unit 341 interfaces with the trick mode cache 335 (via line 53), the access prediction unit 339 (via line 47) and the presentation unit 337 (via line 51).

The cache replacement unit 341 selects which fragments to delete from the trick mode cache 335 when storage is needed to store fragment data received from the disc drive 1 in response to an instruction from the disc control unit 343 to read fragment data. The decision as to which fragments are to be deleted from the trick mode cache 335 takes into consideration the position of each stored fragment in the fragment list, which is retrieved from the access prediction unit 339. In order of precedence, those stored fragments which do not appear on the fragment list are always deleted. If more storage is required after this act, then the stored fragments which appear last on the list are deleted.

It should be noted that the previous description of the preferred embodiments is provided to enable any person skilled in the art to make or use the present invention. The various modifications to these embodiments will be readily apparent to those skilled in the art, as well as other embodiments, without the use of the inventive faculty. Thus, the present invention is not intended to be limited to the embodiments shown herein but is to be accorded the widest scope consistent with the principles and novel features disclosed herein.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A playback apparatus (500) in a reproducing system which includes a plurality of play modes, comprising:
a cache memory (335) configured to store data to be read from a data source (1);
a cache replacement unit (341) configured to identify certain of said stored data to be deleted from the cache memory (335) based on a determination of said stored data's present and/or future use in at least two play modes from among said plurality of play modes; and
a presentation unit (337) configured to retrieve data from the cache memory (335) to be presented to a user.

2. The apparatus of claim 1, further comprising a disc control unit (343) configured to identify and retrieve said data to be read from said data source (1), wherein said identification excludes consideration of currently stored data in the cache memory (335).

3. The apparatus of claim 2, wherein said identified and retrieved data is data suitable for present and/or future use in at least two of said plurality of play modes.

4. The apparatus of claim 3, wherein said data identification is performed via a dynamic prioritization control mechanism that identifies at least two candidate data blocks not currently present in said cache memory (335), assigns a desirability figure to the at least two identified candidate data blocks; and selects one of the at least two candidate data blocks having the highest assigned desirability figure.

5. The apparatus of claim 4, wherein the assigned desirability figure is based on criteria including at least a relative importance metric of the at least two play modes that the at least two candidate data blocks may be used in and a distance between the at least two candidate data blocks to a current playback position.

6. The apparatus of claim 1, further comprising a disc control unit (343) configured to predictively select data stored on the data source (1) based on a heuristic algorithm, said predictively selected data excluding data presently stored in said cache memory (335).

7. The apparatus of claim 6, wherein the heuristic algorithm selects said data from the data source (1) by predicting the likelihood that said data will be requested from the cache memory (335) at a future time, assigning a prediction score based on said prediction, and selecting said data from the data source (1) having the highest prediction scores.

8. The apparatus of claim 7, wherein the heuristic algorithm considers criteria including at least a knowledge of the current play mode, a current playback position, a knowledge of data access patterns in each of said plurality of modes, a probability that a current mode will be maintained and a probability that a mode different than the current play mode will be selected.

9. A playback apparatus (500) in a reproducing system which includes a plurality of play modes, comprising:
a cache memory (335) configured to store data read from a data source (1), said data being comprised of a plurality of data blocks;
a disc control unit (343) configured to identify certain of said plurality of data blocks to be read from the data source (1), said identification based on the current contents of the cache memory (335).
a cache replacement unit (341) configured to identify certain of said data blocks to be deleted from the cache memory (335); and
a presentation unit (337) configured to obtain data from the cache memory (335) to be displayed.

10. The apparatus of claim 9, wherein said certain of said plurality of data blocks to be read from the data source (1) under control of the disc control unit (343) are candidate data blocks applicable for use in at least two of said plurality of data modes.

11. The apparatus of claim 10, wherein said identification of said candidate data blocks is performed via a dynamic prioritization control mechanism.

12. The apparatus of claim 11, wherein said dynamic prioritization control mechanism is configured to identify at least two candidate data blocks not currently present in said cache memory (335), assign a desirability figure to the at least two candidate data blocks; and select a candidate data block from among the at least two candidate data blocks having the highest assigned desirability figure.

13. The apparatus of claim 12, wherein the assigned desirability figure is based on criteria including at least a relative importance of the at least two play modes that the at least two candidate data blocks may be used in and a distance between the at least two candidate data blocks to a current playback position.

14. A playback apparatus (500) in a reproducing system which includes a plurality of play modes, the apparatus comprising:
an access prediction unit (339), configured to predictively select data blocks to be read from a data source (1), wherein said selected data is usable in at least two play modes from among said plurality of play modes;
a disc control unit (343) configured to read said predictively selected data blocks from said data source;
a cache (335) configured to store the predictively selected data blocks read from the data source (1); and
a presentation unit (337) configured to request data blocks from the cache (335) to be presented to a user.

15. The apparatus of claim 14, wherein said access prediction unit (339) predictively selects fragments in accordance with a heuristic algorithm.

16. The apparatus of claim 15, wherein said heuristic algorithm predicts the likelihood that data blocks to be read from the data source (1) will be retrieved from the cache memory (335) in the fixture and selecting the data blocks having the highest likelihood to be retrieved.

17. The apparatus of claim 16, further comprising a cache replacement unit configured to identify certain of said data blocks to be deleted from the cache memory.

18. A method for improving trick mode performance in a playback apparatus in a reproducing system which includes a plurality of play modes, the method comprising the acts of:
reading data from a data source (1);
storing said data in a cache memory (335);
identifying certain of said stored data to be deleted from the cache memory (335) based on a determination of said stored data's present and/or future use in at least two play modes from among said plurality of play modes; and
retrieving data from the cache memory (335) to be displayed.

19. The method of claim 18, further comprising the acts of:
identifying said data read from said data source (1), wherein said data excludes consideration of currently stored in the cache memory (335);
retrieving said identified data from said data source (1); and
storing said retrieved data in said cache memory (335).

20. The method of claim 19, wherein said identification act is based on said data's present and/or future use in at least two of said plurality of play modes.

21. The method of claim 20, wherein said data identification is performed via a dynamic prioritization control mechanism comprising the acts of:
identifying at least two candidate data blocks not currently present in said cache memory (335);
assigning a desirability figure to the at least two identified candidate data blocks; and
selecting one of the at least two candidate data blocks having the highest assigned desirability figure.

22. The method of claim 20, wherein the assigned desirability figure is based on criteria including at least a relative importance metric of the at least two play modes that the at least two candidate data blocks may be used in and a distance between the at least two candidate data blocks to a current playback position.

23. The method of claim 18, further comprising the act of predictively selecting said data stored on the data source (1) based on a heuristic algorithm, wherein said predictively selected data excludes data presently stored in said cache memory (335).

24. The method of claim 23, wherein the heuristic algorithm predictively selects said data from the data source (1) in accordance with the following acts:
predicting the likelihood that said data will be requested from the cache memory (335) at a future time;
assigning a prediction score based on said prediction; and
selecting said data from the data source (1) having the highest prediction scores.

25. The method of claim 24, wherein the heuristic algorithm considers criteria including at least a knowledge of the current play mode, a current fragment position, a knowledge of fragment access patterns in each of said plurality of modes, a probability that a current mode will be maintained and a probability that a mode different than the current play mode will be selected.
